(19) United States
(12) Patent Application Publication
(10) Pub. No.: US 2026/0156174 A1
(43) Pub. Date: Jun. 4, 2026

(54) INFORMATION PROCESSING METHOD

(71) Applicant: SEIKO EPSON CORPORATION, Tokyo (JP)

(72) Inventors: Jun ISHIDA, SAPPORO-SHI (JP); Ikuto KANBARA, MATSUMOTO-SHI (JP)

(21) Appl. No.: 19/400,746

(22) Filed: Nov. 25, 2025

(30) Foreign Application Priority Data
Nov. 29, 2024 (JP) 2024-208138

(51) Int. Cl. H04L 67/025; H04N 9/31

(52) U.S. Cl. CPC H04L 67/025; H04N 9/31

(57) ABSTRACT

An information processing method includes: establishing a communication connection with a projection apparatus; storing an application program for controlling the projection apparatus; executing the application program; causing the application program to launch a web application program on a web browser; causing the application program to transmit a control signal to the projection apparatus via a signal communication path; and causing the web application program to acquire output data including at least one of video data and audio data output from an outputter.

The present application is based on, and claims priority from JP Application Serial Number 2024-208138, filed Nov. 29, 2024, the disclosure of which is hereby incorporated by reference herein in its entirety.

### BACKGROUND

### 1. Technical Field

The present disclosure relates to an information processing method.

### 2. Related Art

A system including a display or projector and a controller is known. A system disclosed in JP-A-2022-140564 includes a projection system that is an example of a display or projector and an information processing apparatus that is an example of a controller. The projection system and the information processing apparatus are communicatively connected via a network. The projection system receives image data and the like from the information processing apparatus and projects the image data. The information processing apparatus operates on an operating system such as Windows, Android, or iOS. Windows, Android, and iOS are registered trademarks.

JP-A-2022-140564 is an example of the related art.

Depending on a model of the information processing apparatus and a type of the operating system operating in the information processing apparatus, an anomaly may occur when the image data is output to an external device such as a projection system.

### SUMMARY

An information processing method according to the disclosure includes: establishing a communication connection with a projection apparatus; storing an application program for controlling the projection apparatus; executing the application program; causing the application program to launch a web application program on a web browser; causing the application program to transmit a control signal to the projection apparatus via a signal communication path; and causing the web application program to acquire output data including at least one of video data and audio data output from an outputter.

### BRIEF DESCRIPTION OF THE DRAWINGS

FIG. 1 is a diagram illustrating a schematic configuration of a system.

FIG. 2 is a diagram illustrating a block configuration of the system.

FIG. 3 is a diagram illustrating a schematic configuration of a projector.

FIG. 4 is a diagram illustrating a system configuration of the system.

FIG. 5 is a diagram illustrating an example of a display screen.

FIG. 6 is a diagram illustrating a control flow executed by a controller.

FIG. 7 is a diagram illustrating a system configuration of the system.

FIG. 8 is a diagram illustrating a control flow executed by the controller.

FIG. 9 is a diagram illustrating a system configuration of the system.

FIG. 10 is a diagram illustrating a control flow executed by the controller.

### DESCRIPTION OF EMBODIMENTS

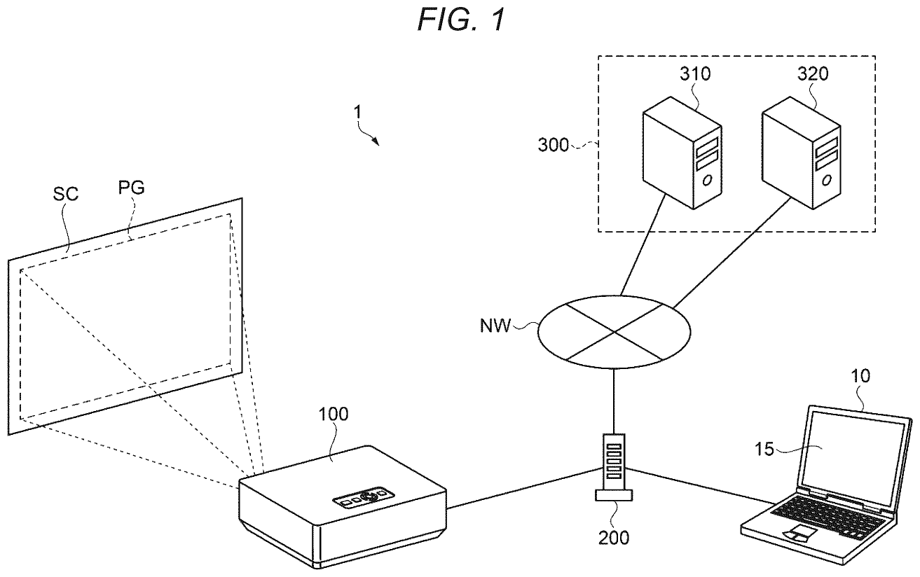

FIG. 1 illustrates a schematic configuration of a system 1. The system 1 includes a controller 10, a projection system 100, a router 200, and a cloud server 300. The projection system 100 projects a projection image PG onto a projection surface SC. The cloud server 300 is communicatively connected to the controller 10 via a communication network NW. The system 1 illustrated in FIG. 1 includes one controller 10 and one projection system 100, but is not limited thereto. The system 1 may include a plurality of controllers 10 and a plurality of projection systems 100.

The controller 10 is communicatively connected to the projection system 100. The controller 10 transmits projection image data to the projection system 100. The controller 10 executes mirroring for causing the projection system 100 to project, as the projection image PG, a display screen DS displayed on a display 15. The controller 10 may have a function of adjusting an image shape and the like of the projection image PG projected onto the projection surface SC by the projection system 100. The controller 10 corresponds to an example of an information processing apparatus. The controller 10 is a tablet terminal, a mobile computer, a desktop personal computer, or the like. FIG. 1 illustrates, as the controller 10, a mobile personal computer including the display 15.

The controller 10 executes various programs such as a web browser 80 on a dedicated operating system 70. The dedicated operating system 70 is, as an example, Chrome OS. Chrome is a registered trademark. The dedicated operating system 70 corresponds to an example of an operating system. The dedicated operating system 70 can construct a virtual environment. In the virtual environment, a program operating on an operating system different from the dedicated operating system 70 is operable. The operating system different from the dedicated operating system 70 is, as an example, Android OS. The program operating on the operating system different from the dedicated operating system 70 is, as an example, an Android application.

The display 15 displays screens including various videos and various images. The display 15 includes a liquid crystal panel or an organic electro-luminescence (EL) panel. The display 15 may have a touch input function for receiving an input operation from a user.

The projection system 100 is disposed at a position facing the projection surface SC. The projection system 100 is communicatively connected to the controller 10. The projection system 100 corresponds to an example of a projection apparatus. The projection system 100 may be communicatively connected to an external apparatus different from the controller 10. The projection system 100 receives the projection image data from the controller 10. The projection system 100 projects the projection image PG onto the projection surface SC based on the projection image data. The projection system 100 may mirror the display screen DS displayed on the display 15 of the controller 10 based on the projection image data. The projection system 100 may project the projection image PG onto the projection surface SC based on OSD data stored in advance. OSD is an abbreviation for on-screen display.

The projection surface SC displays the projection image PG projected from the projection system 100. The projection surface SC illustrated in FIG. 1 includes a screen but is not limited thereto. The projection surface SC may be an indoor wall, a ceiling, an outer wall of a building, or the like. A surface shape of the projection surface SC is not limited to a flat surface and may be a three-dimensional shape such as a curved surface, an uneven surface, or a spherical surface.

The router 200 is a communication device that interconnects the controller 10, the projection system 100, and the cloud server 300. The router 200 communicatively connects the controller 10 and the cloud server 300 via the communication network NW. The router 200 communicatively connects the controller 10 and the projection system 100 using a predetermined communication protocol. The router 200 may communicatively connect the projection system 100 and the cloud server 300.

The communication network NW communicatively connects the cloud server 300, the controller 10, and the like. The communication network NW is, as an example, a wide area network (WAN).

The cloud server 300 is a virtual server that operates in a cloud computing environment. The cloud server 300 is a service that uses one or a plurality of virtualized servers via the Internet. The cloud server 300 illustrated in FIG. 1 includes a web server 310 and a WebSocket server 320.

The web server 310 provides displays of HTML and objects to the web browser 80 of client software. FIG. 1 virtually illustrates the web server 310. The web server 310 provides a web application to the web browser 80 of the controller 10 based on an instruction from the controller 10. When the controller 10 or the like stores the web application in advance, the system 1 may not include the web server 310.

The WebSocket server 320 is a server that performs data communication with the web application on the web browser 80 according to the WebSocket protocol. FIG. 1 virtually illustrates the WebSocket server 320. The WebSocket server 320 is used as an SDP exchange signaling server when shared data or the like is distributed by streaming using Web Real-Time Communication (WebRTC) technology. SDP is an abbreviation for Session Description Protocol.

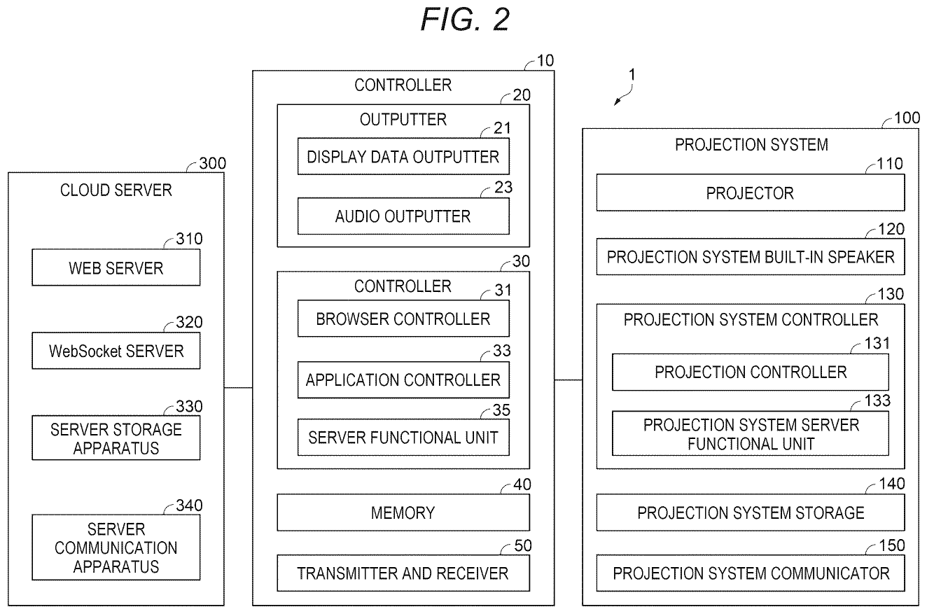

FIG. 2 illustrates a block configuration of the system 1. FIG. 2 illustrates a block configuration of the controller 10, the projection system 100, and the cloud server 300 in the system 1. FIG. 2 illustrates the system 1 in which the router 200 is omitted.

The controller 10 includes an outputter 20, a controller 30, a memory 40, and a transmitter and receiver 50. The controller 10 may include the display 15, an inputter, and the like, which are not illustrated in FIG. 2.

The outputter 20 outputs various types of generated data generated by the controller 30 and the like to the display 15 and the like. The outputter 20 includes various circuits and output terminals. The outputter 20 corresponds to an example of an outputter. The outputter 20 includes a display data outputter 21 and an audio outputter 23.

The display data outputter 21 outputs video data for displaying a video to the display 15. The video data includes image data for displaying a still image. The video data is within the generated data. The video data is transferred from the WebSocket server 320 to the controller 10 using WebRTC technology. The display data outputter 21 may output the video data or the like to a display or projector externally attached to the controller 10.

The audio outputter 23 outputs audio data related to an audio. The audio data is within the generated data. The audio data is transferred from the WebSocket server 320 to the controller 10 using WebRTC technology. The audio outputter 23 is coupled to a speaker (not illustrated) and the like. The speaker and the like may be built in the controller 10 or may be externally attached to the controller 10. The audio outputter 23 outputs the audio data in a wired or wireless manner.

The controller 30 is a device controller that controls the units of the controller 10. The controller 30 is, as an example, a processor including a central processing unit (CPU). The controller 30 includes one or a plurality of processors. The dedicated operating system 70 operates in the controller 30. The controller 30 executes various programs on the dedicated operating system 70. The controller 30 functions as various functional units by executing the various programs. As an example, the controller 30 functions as a browser controller 31 and an application controller 33. The controller 30 may function as a server functional unit 35. The controller 30 may function as functional units other than the browser controller 31, the application controller 33, and the server functional unit 35.

The browser controller 31 causes the web browser 80 to operate on the dedicated operating system 70 to display a web page or the like. The browser controller 31 causes the web application to operate on the web browser 80 to execute a function of the web application. As an example, the browser controller 31 causes a capture application 81, which is the web application, to operate on the web browser 80, and to capture at least one of the video data and the audio data. Details of the capture application 81 will be described later.

The application controller 33 causes an application to operate on the dedicated operating system 70 or in the virtual environment. The application controller 33 causes an application having a specification corresponding to the dedicated operating system 70 to operate on the dedicated operating system 70. The application controller 33 causes an application having a specification different from the specification corresponding to the dedicated operating system 70 to operate in the virtual environment. The virtual environment is constructed in a virtual device 90 that operates on the dedicated operating system 70. The virtual device 90 will be described later.

The server functional unit 35 constructs various server functions in the controller 10. The server functional unit 35 operates as a virtual server. When the server functional unit 35 operates as the virtual server, the controller 10 has a server function. As for the server functional unit 35, as an example, when a projection application 91 instructs construction of a virtual web server 35a or the like that is the virtual server in the controller 10, the server functional unit 35 operates as the virtual web server 35a or the like in the controller 10. The projection application 91 and the virtual web server 35a will be described later.

The memory 40 stores various programs, various data, and the like. The memory 40 stores a device control program, various web applications, various applications, and the like. The memory 40 stores various data and the like generated by the controller 30. The memory 40 includes a volatile semiconductor memory such as a random access memory (RAM) and a nonvolatile memory such as a read only memory (ROM) or a flash memory. The memory 40 may function as a work area for the controller 30. The memory 40 corresponds to an example of a storage.

The transmitter and receiver 50 is a communication interface circuit that communicates with the projection system 100, the cloud server 300, and the like. The transmitter and receiver 50 is wirelessly connected to the projection system 100 and the like according to a predetermined communication protocol. The transmitter and receiver 50 includes a wireless communication port. The wireless communication port is a wireless local area network (LAN) communication port or the like. The transmitter and receiver 50 may be coupled to the projection system 100 and the like in a wired manner. The transmitter and receiver 50 includes a wired connector such as a universal serial bus (USB). The transmitter and receiver 50 transmits various control signals, the projection image data, and the like to the projection system 100. The projection image data includes the video data, the audio data, and the like. The transmitter and receiver 50 receives various data, response signals, and the like from the cloud server 300 and the like.

The projection system 100 includes a projector 110, a projection system built-in speaker 120, a projection system controller 130, a projection system storage 140, and a projection system communicator 150.

The projector 110 enlarges and projects image light onto the projection surface SC based on the projection image data. The projector 110 projects the projection image PG onto the projection surface SC based on control by the projection system controller 130. The projector 110 projects a moving image, a still image, an OSD image, or the like as the projection image PG based on the video data in the projection image data and the like. The OSD image is an image showing various types of setting, operation information, and the like related to the projection system 100.

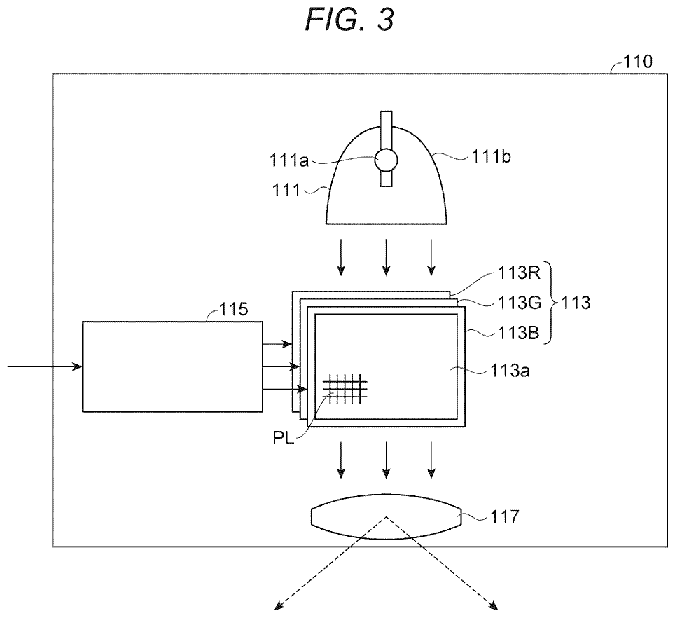

FIG. 3 illustrates a schematic configuration of the projector 110. FIG. 3 illustrates an example of the projector 110. The projector 110 includes a light source 111, three liquid crystal light valves 113, a light bulb driver 115, and a projection lens 117.

The light source 111 emits light to each liquid crystal light valve 113. The light source 111 includes a light source 111a, a reflector 111b, an integrator optical system (not illustrated), and a color separation optical system (not illustrated). The light source 111a emits light. The light source 111a includes a xenon lamp, an ultra-high-pressure mercury lamp, a light emitting diode (LED), or a laser light source. The light source 111a emits light based on control by the projection system controller 130. The reflector 111b reduces variations in an emission direction of the light emitted by the light source 111a. The integrator optical system reduces variations in a luminance distribution of the light emitted by the light source 111a. The light having passed through the reflector 111b is incident on the color separation optical system. The color separation optical system separates the incident light into red, green, and blue color light components.

The liquid crystal light valve 113 modulates the light emitted from the light source 111. The liquid crystal light valve 113 modulates the light to generate the projection image PG and the like. The liquid crystal light valve 113 includes a transmissive liquid crystal panel where liquid crystal is sealed between a pair of transparent substrates. The liquid crystal light valve 113 has a rectangular pixel region 113a including a plurality of pixels PL arrayed in a matrix. In the liquid crystal light valve 113, a drive voltage is applied to the liquid crystal for each of the pixels PL. The projection system 100 illustrated in FIG. 3 includes the three liquid crystal light valves 113. A configuration is adopted in which the projection system 100 uses the transmissive liquid crystal panel provided at each liquid crystal light valve 113, but the configuration is not limited thereto. The projection system 100 may include a reflective liquid crystal panel or a liquid-crystal-on-silicon (LCOS) liquid crystal panel. The projection system 100 may include one or more digital mirror devices (DMDs).

The three liquid crystal light valves 113 are a red light liquid crystal light valve 113R, a green light liquid crystal light valve 113G, and a blue light liquid crystal light valve 113B. A red color light component separated by the color separation optical system is incident on the red light liquid crystal light valve 113R. A green color light component separated by the color separation optical system is incident on the green light liquid crystal light valve 113G. A blue color light component separated by the color separation optical system is incident on the blue light liquid crystal light valve 113B.

The light bulb driver 115 applies the drive voltage to the pixels PL based on the projection image data received from the projection system controller 130. The light bulb driver 115 is, for example, a control circuit. The drive voltage is supplied by a drive source (not illustrated). The light bulb driver 115 may apply the drive voltage to the pixels PL based on projection image data corrected by a projection controller 131 to be described later. When the light bulb driver 115 applies the drive voltage to the pixels PL, the pixels PL are set to a light transmittance based on the projection image data. The light emitted from the light source 111 is modulated by being transmitted through the pixel region 113a. The three liquid crystal light valves 113 form color component images for light of each color.

The projection lens 117 combines the color component images formed by the liquid crystal light valves 113 and enlarges and projects a combined image. The projection lens 117 projects the projection image PG onto the projection surface SC. The projection image PG is a multi-color image obtained by combining the color component images.

The projection system built-in speaker 120 illustrated in FIG. 2 outputs an audio based on the audio data in the projection image data. The projection system built-in speaker 120 receives the audio data from the projection system controller 130 and outputs the audio corresponding to the audio data. The projection system 100 illustrated in FIG. 2 includes the projection system built-in speaker 120 but is not limited thereto. The projection system 100 may include an external speaker. The external speaker outputs the audio based on the audio data.

The projection system controller 130 is a projection system controller that controls the units of the projection system 100. The projection system controller 130 is, as an example, a processor including a CPU. The projection system controller 130 includes one or a plurality of processors. The projection system controller 130 functions as the projection controller 131 by executing firmware. The projection system controller 130 may function as a projection system server functional unit 133 by executing firmware. The projection system controller 130 may function as a functional unit other than the projection controller 131 and the projection system server functional unit 133.

The projection controller 131 controls projection from the projector 110. The projection controller 131 causes the projector 110 to project the projection image PG based on the video data in the projection image data transmitted from the controller 10. The projection controller 131 causes the projection system built-in speaker 120 to output the audio based on the audio data in the projection image data. The projection controller 131 synchronizes the projection image PG projected from the projector 110 with the audio output from the projection system built-in speaker 120. The projection controller 131 performs various types of correction processing such as keystone correction on the video data.

The projection system server functional unit 133 constructs various server functions in the projection system 100. As for the projection system server functional unit 133, as an example, when firmware has a function of executing a server function, the projection system server functional unit 133 operates as a virtual server in the projection system 100. When the projection system server functional unit 133 operates as the virtual server, the projection system 100 has the server function.

The projection system storage 140 stores firmware, various data, and the like. The projection system storage 140 stores the projection image data transmitted from the controller 10, correction data for correcting the video data in the projection image data, and the like. The projection system storage 140 includes a volatile semiconductor memory such as a RAM and a nonvolatile memory such as a ROM or a flash memory.

The projection system communicator 150 is a communication interface circuit that communicates with the controller 10, an external apparatus, and the like. The projection system communicator 150 is connected to the controller 10 and the like wirelessly according to a predetermined communication protocol. The projection system communicator 150 includes a wireless communication port. The wireless communication port is a wireless LAN communication port or the like. The projection system communicator 150 may be coupled to the controller 10 and the like in a wired manner. The projection system communicator 150 includes a wired connector such as a USB. The projection system communicator 150 receives the projection image data, the control signal, and the like from the controller 10. The projection system communicator 150 transmits various data such as projection system setting information to the controller 10 and the like.

The cloud server 300 includes the web server 310, the WebSocket server 320, a server storage apparatus 330, and a server communication apparatus 340. The web server 310, the WebSocket server 320, the server storage apparatus 330, and the server communication apparatus 340 are implemented in one or a plurality of apparatuses.

The server storage apparatus 330 stores various programs, various data, and the like. The server storage apparatus 330 stores a web page, a web application, and the like provided from various web servers 310. The server storage apparatus 330 includes a magnetic recording medium such as a hard disk drive (HDD). The server storage apparatus 330 may include a volatile semiconductor memory such as a RAM, or a nonvolatile memory such as a ROM or a flash memory.

The server communication apparatus 340 is a communication interface circuit that communicates with the controller 10 and the like. The server communication apparatus 340 is connected to the controller 10 or the like in a wired or wireless manner according to a predetermined communication protocol. The server communication apparatus 340 includes a wired connector, a wireless communication port, and the like. The wired connector is a USB connector, a LAN connector, or the like. The wireless communication port is a Wi-Fi communication port, a Bluetooth communication port, or the like. Wi-Fi and Bluetooth are registered trademarks. The server communication apparatus 340 transmits the web application to the controller 10. The server communication apparatus 340 receives various signals transmitted from the controller 10.

### First Embodiment

A first embodiment shows a system configuration and a control flow of a first system 1a that is an example of the system 1. In the first system 1a, the controller 10 constructs a system configuration for transmitting shared data to the projection system 100 using the cloud server 300. The shared data includes at least one of video data and audio data. The shared data corresponds to an example of output data. As an example, the controller 10 transmits the shared data to the projection system 100 to execute mirroring for causing the projection system 100 to project the display screen DS displayed on the display 15. In the first system 1a, the web server 310 in the cloud server 300 provides a web application to the controller 10. The controller 10 transmits and receives various signals using the WebSocket server 320 in the cloud server 300. In the first system 1a, the server functional unit 35 and the projection system server functional unit 133 do not operate as a virtual server.

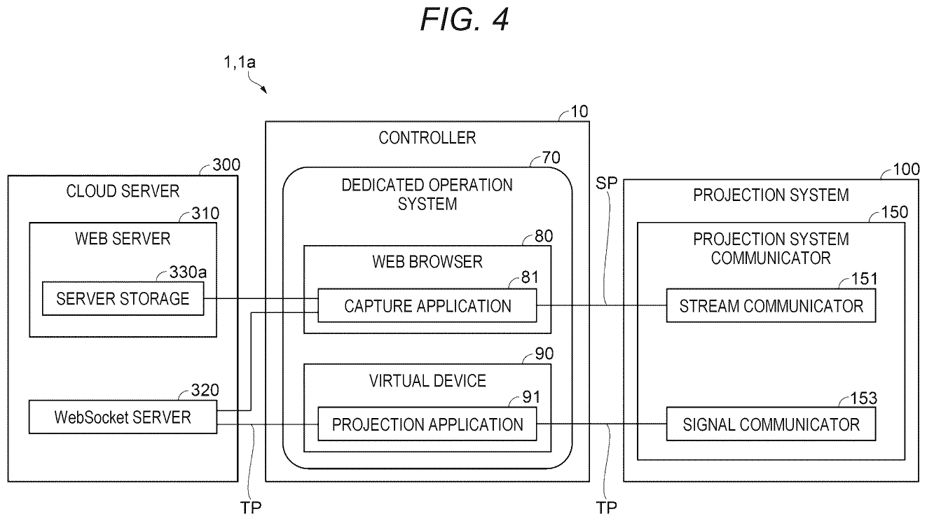

FIG. 4 illustrates a system configuration of the system 1. FIG. 4 schematically illustrates a system configuration of the first system 1a, which is an example of the system 1. FIG. 4 illustrates the controller 10, the projection system 100, and the cloud server 300.

In the controller 10, the dedicated operating system 70 operates. In the first embodiment, the dedicated operating system 70 is Chrome OS. The controller 30 of the controller 10 causes the dedicated operating system 70 to operate. An application corresponding to the dedicated operating system 70 is operable on the dedicated operating system 70. The web browser 80 and the virtual device 90 operate on the dedicated operating system 70 illustrated in FIG. 4. An application other than the web browser 80 and the virtual device 90 may operate on the dedicated operating system 70.

The web browser 80 is software that connects to the web server 310. The web browser 80 operates on the dedicated operating system 70. The web browser 80 is, as an example, Chrome. The web browser 80 launches various web applications. The web browser 80 illustrated in FIG. 4 can launch the capture application 81. The capture application 81 is an example of the web application.

The capture application 81 is launched on the web browser 80. The web browser 80 illustrated in FIG. 4 acquires the capture application 81 from the web server 310. The capture application 81 captures, as capture data, generated data output from the outputter 20 of the controller 10. The generated data includes at least one of the video data output from the display data outputter 21 and the audio data output from the audio outputter 23. The capture data includes at least one of the video data and the audio data. The capture application 81 transmits the capture data, as the shared data, to the projection system 100 via a stream distribution path SP. The capture application 81 may transmit the capture data to the projection application 91. The capture application 81 corresponds to an example of a web application program.

The virtual device 90 is a virtual apparatus that operates on the dedicated operating system 70. The virtual device 90 is an example of an emulator that operates on the dedicated operating system 70. The virtual device 90 functions as a device that causes an operating system different from the dedicated operating system 70 to operate on the dedicated operating system 70. The virtual device 90 provides a virtual environment on the dedicated operating system 70. The virtual device 90 is, as an example, a device where Android OS operates. An application operating on the operating system different from the dedicated operating system 70 can be launched in the virtual device 90. The application operating on the operating system different from the dedicated operating system 70 is an Android application. The projection application 91 illustrated in FIG. 4 is an example of the Android application.

The projection application 91 is software that controls the projection system 100. The projection application 91 is stored in the memory 40 in advance. The projection application 91 causes the projection system 100 to project various projection images PG. The projection application 91 transmits various control signals to the projection system 100, the cloud server 300, and the like. The projection application 91 receives a response signal or the like from the projection system 100, the cloud server 300, or the like. The projection application 91 causes the capture application 81 to acquire the shared data. The projection application 91 may cause the capture application 81 to transmit the shared data to the projection system 100. The projection application 91 corresponds to an example of the application program.

The projection application 91 operating in the virtual device 90 transmits or receives various control signals and the like to and from the dedicated operating system 70 via various application programming interfaces (API). The API is different depending on a version or the like of the operating system operating in the virtual device 90. Depending on the version of the operating system operating in the virtual device 90, it may be difficult for the projection application 91 to control the projection system 100. The projection application 91 controls the projection system 100 using functions of the web browser 80 and the cloud server 300.

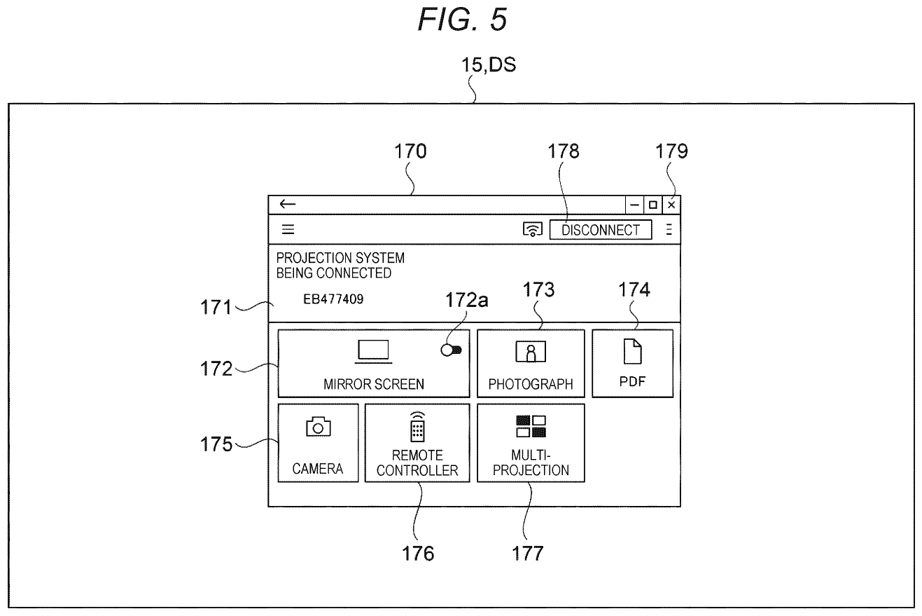

FIG. 5 illustrates an example of the display screen DS. The display screen DS is displayed on the display 15. The display screen DS illustrated in FIG. 5 indicates the display screen DS at the time when the controller 10 launches the projection application 91. The display screen DS includes a UI screen 170 of the projection application 91. UI is an abbreviation for a user interface.

The UI screen 170 displays a plurality of icons and the like. The UI screen 170 includes a projection system name display 171, a mirroring reception icon 172, a photograph display reception icon 173, a document display reception icon 174, a camera image display reception icon 175, a remote controller function reception icon 176, a multi-projection reception icon 177, a disconnection reception icon 178, and an end reception icon 179.

The projection system name display 171 displays a projection system name of the projection system 100 coupled to the controller 10. The projection system name display 171 displays the projection system name based on model information on the projection system 100 acquired from the projection system 100.

The mirroring reception icon 172 receives a mirroring instruction from the user. When the user executes a predetermined operation on the mirroring reception icon 172, the mirroring reception icon 172 receives the mirroring instruction. Upon receiving the mirroring instruction, the projection application 91 generates a mirroring control signal corresponding to the mirroring instruction. The mirroring reception icon 172 includes a switch icon 172a.

The switch icon 172a indicates whether the projection system 100 is executing mirroring. By checking the display of the switch icon 172a, the user can determine whether the projection system 100 is executing mirroring. The switch icon 172a may receive the mirroring instruction from the user.

The photograph display reception icon 173 receives a photograph display instruction from the user. When the user executes a predetermined operation on the photograph display reception icon 173, the photograph display reception icon 173 receives the photograph display instruction. Upon receiving the photograph display instruction, the projection application 91 performs photograph display processing of causing the projection system 100 to project a photograph image stored by the controller 10. The projection application 91 transmits photograph image data for displaying the photograph image to the projection system 100 and causes the projection system 100 to project the photograph image as the projection image PG.

The document display reception icon 174 receives a document display instruction from the user. When the user executes a predetermined operation on the document display reception icon 174, the document display reception icon 174 receives the document display instruction. Upon receiving the document display instruction, the projection application 91 performs document display processing of causing the projection system 100 to project a PDF file or the like stored by the controller 10. The projection application 91 transmits, as an example, PDF data for displaying a PDF image to the projection system 100 and causes the projection system 100 to project the PDF image as the projection image PG.

The camera image display reception icon 175 receives a camera image display instruction from the user. When the controller 10 includes an imaging apparatus such as a camera, the camera image display reception icon 175 can be operated. When the user executes a predetermined operation on the camera image display reception icon 175, the camera image display reception icon 175 receives the camera image display instruction. Upon receiving the camera image display instruction, the projection application 91 performs camera image display processing of causing the projection system 100 to project a captured image captured by the imaging apparatus. The projection application 91 transmits imaging data for displaying the captured image to the projection system 100 and causes the projection system 100 to project the captured image as the projection image PG.

The remote controller function reception icon 176 receives a remote controller function operation instruction from the user. When the user executes a predetermined operation on the remote controller function reception icon 176, the remote controller function reception icon 176 receives the remote controller function operation instruction. Upon receiving the remote controller function operation instruction, the projection application 91 displays a remote controller image indicating a remote controller for operating the projection system 100 on the projection image PG. When the user performs an input operation on the remote controller image, control corresponding to the input operation on the projection system 100 can be performed.

The multi-projection reception icon 177 receives a multi-projection instruction from the user. The multi-projection reception icon 177 can be operated when a plurality of projection systems 100 are coupled to the controller 10. When the user executes a predetermined operation on the multi-projection reception icon 177, the multi-projection reception icon 177 receives the multi-projection instruction. The projection application 91 executes multi-projection for causing the plurality of projection systems 100 coupled to the controller 10 to project the projection image PG onto the projection surface SC.

The disconnection reception icon 178 receives a disconnection instruction from the user. When the user executes a predetermined operation on the disconnection reception icon 178, the disconnection reception icon 178 receives the disconnection instruction. Upon receiving the disconnection instruction, the projection application 91 disconnects the communication connection between the controller 10 and the projection system 100.

The end reception icon 179 receives an end instruction from the user. When the user performs a predetermined operation on the end reception icon 179, the end reception icon 179 receives the end instruction. Upon receiving the end instruction, the projection application 91 stops operating. The projection application 91 hides the UI screen 170.

The stream distribution path SP illustrated in FIG. 4 is a path for performing real-time communication between the web browser 80 and the projection system 100. The stream distribution path SP performs communication using, as an example, WebRTC technology. The web browser 80 can transmit the shared data to the projection system 100 via the stream distribution path SP. Since the web browser 80 transmits the shared data to the projection system 100 via the stream distribution path SP, the controller 10 can transmit the shared data to the projection system 100 without shared data quality deterioration. The stream distribution path SP corresponds to an example of a browser communication path.

A TCP/IP communication path TP is a path for performing communication using TCP/IP (Transmission Control Protocol/Internet Protocol). The TCP/IP communication path TP and the stream distribution path SP are communication paths different from each other. The projection application 91 transmits various control signals to the projection system 100 via the TCP/IP communication path TP. The projection application 91 receives a control signal from the projection system 100 via the TCP/IP communication path TP. The projection application 91 may transmit the shared data to the projection system 100 via the TCP/IP communication path TP. When the shared data is transmitted to the projection system 100 via the TCP/IP communication path TP, the quality of the shared data may deteriorate depending on a situation of the virtual device 90. The shared data is preferably transmitted to the projection system 100 via the stream distribution path SP. The TCP/IP communication path TP corresponds to an example of a signal communication path.

The projection system communicator 150 of the projection system 100 includes a stream communicator 151 and a signal communicator 153.

The stream communicator 151 is communicatively connected to the capture application 81 via the stream distribution path SP. The stream communicator 151 supports WebRTC technology. The stream communicator 151 receives the shared data transmitted from the capture application 81 by real-time communication.

The signal communicator 153 is communicatively connected to projection application 91 via the TCP/IP communication path TP. The signal communicator 153 receives a control signal from the projection application 91. The signal communicator 153 transmits the control signal generated by the projection system 100 to the projection application 91. Since the signal communicator 153 transmits and receives the control signal between the projection application 91 and the projection system 100, the projection application 91 can control the projection system 100.

The web server 310 in the cloud server 300 includes a server storage 330a. The server storage 330a is a part of the server storage apparatus 330. The server storage 330a stores various web applications including the capture application 81. The web server 310 provides the web application stored in the server storage 330a to the web browser 80.

The WebSocket server 320 receives various control signals transmitted from the projection application 91 via the TCP/IP communication path TP. Each control signal transmitted from the projection application 91 includes a web page request. The web page request is a signal for instructing transmission of a web page including the web application from the web server 310 to the web browser 80. Upon receiving the web page request, the WebSocket server 320 transmits the web page request to the web server 310. The web server 310 transmits the web page including the web application to the web browser 80 based on the web page request.

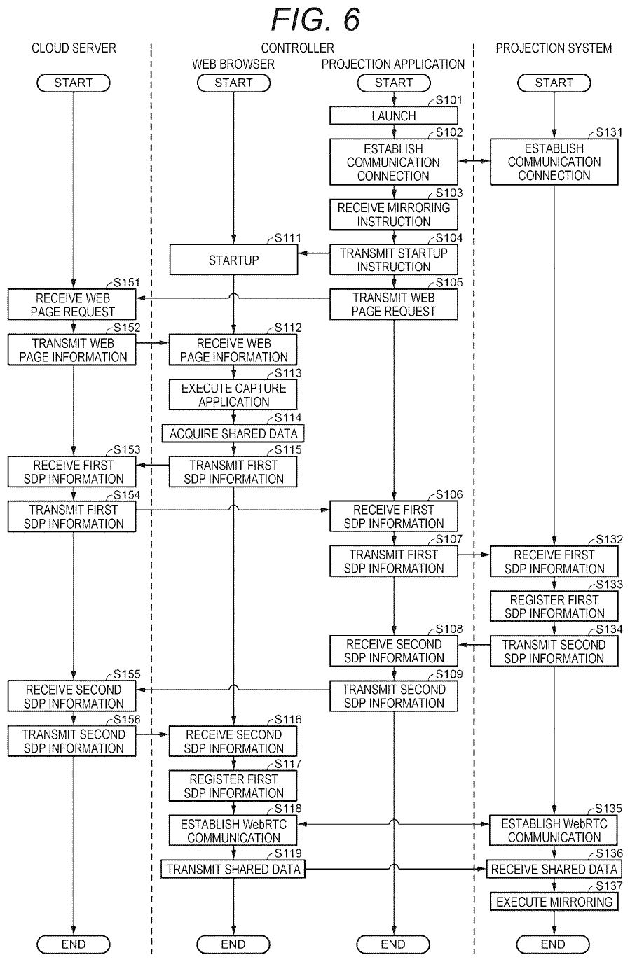

FIG. 6 illustrates a control flow executed by the system 1. FIG. 6 illustrates a control flow executed by the first system 1a, which is an example of the system 1. FIG. 6 illustrates a control flow executed by the controller 10, the projection system 100, and the cloud server 300. The control flow executed by the controller 10 corresponds to an example of an information processing method. The controller 10 executes the control flow to execute mirroring for causing the projection system 100 to project the display screen DS displayed on the display 15.

In step S101, the controller 10 launches the projection application 91. Upon receiving a predetermined operation from the user, the controller 10 launches the projection application 91. The projection application 91 is launched in the virtual device 90. The projection application 91 is executed in a virtual environment.

After launching the projection application 91, the controller 10 establishes communication connection with the projection system 100 in step S102. The projection application 91 transmits, to the projection system 100, a control signal such as a request for connection with the projection system 100 via the TCP/IP communication path TP to establish communication connection with the projection system 100.

After the projection application 91 is launched, the projection system 100 establishes communication connection with the controller 10 in step S131. The projection system 100 receives the control signal such as the connection request from the projection application 91 via the TCP/IP communication path TP. The projection system 100 transmits various data such as model information to establish the communication connection with the controller 10. When the communication connection with the controller 10 is established, the projection system 100 can receive various data from the controller 10.

After establishing the communication connection with the projection system 100, the controller 10 receives the mirroring instruction in step S103. When launched, the projection application 91 causes the display 15 to display the UI screen 170. When the user executes the predetermined operation on the mirroring reception icon 172 in the UI screen 170 displayed on the display 15, the mirroring reception icon 172 receives the mirroring instruction. Upon receiving the mirroring instruction, the projection application 91 generates various control signals such as the mirroring control signal corresponding to the mirroring instruction.

After receiving the mirroring instruction, the controller 10 transmits a startup instruction to the controller 30 in step S104. The projection application 91 transmits the startup instruction to the browser controller 31 of the controller 30. The browser controller 31 receives the startup instruction.

When the projection application 91 transmits the startup instruction to the browser controller 31, the controller 10 causes the web browser 80 to start up in step S111. When the web browser 80 is not launched, the browser controller 31 of the controller 30 causes the web browser 80 to start up based on the startup instruction. The web browser 80 is launched based on the startup instruction and displays a web page tab. The browser controller 31 displays a new web page tab when the web browser 80 starts up at the time of receiving the startup instruction.

After receiving the mirroring instruction, the controller 10 transmits the web page request to the cloud server 300 in step S105. The projection application 91 transmits the web page request to the WebSocket server 320 in the cloud server 300 via the TCP/IP communication path TP. The web page request is a request for causing the web browser 80 to transmit a web page where the capture application 81 operates. The web page request includes a page address of the web page where the capture application 81 operates. The page address is stored in the memory 40 when the projection application 91 is installed in the controller 10.

When the projection application 91 transmits the web page request, the cloud server 300 receives the web page request in step S151. The WebSocket server 320 in the cloud server 300 receives the web page request transmitted from the projection application 91 via the TCP/IP communication path TP. The WebSocket server 320 transmits the web page request to the web server 310. The web server 310 receives the web page request.

Upon receiving the web page request, the cloud server 300 transmits web page information to the web browser 80 in step S152. The web server 310 acquires the web page information stored in the server storage 330a based on the page address in the web page request. The web page information is information on the web page where the capture application 81 operates. The web server 310 transmits the web page information to the web browser 80.

When the cloud server 300 transmits the web page information, the controller 10 receives the web page information in step S112. Upon receiving the web page information, the web browser 80 displays the web page where the capture application 81 operates in the web page tab based on the web page information. The web browser 80 can execute the capture application 81.

After receiving the web page information, the controller 10 executes the capture application 81 in step S113. The web browser 80 executes the capture application 81 in the web page tab.

After executing the capture application 81, the controller 10 acquires the shared data in step S114. The web browser 80 causes the capture application 81 to acquire the shared data. The capture application 81 captures, as the capture data, the generated data output from the outputter 20 of the controller 10. The generated data includes at least one of the video data output from the display data outputter 21 and the audio data output from the audio outputter 23. The capture data is an example of the shared data including at least one of the video data and the audio data.

Upon acquiring the shared data, the controller 10 transmits first SDP information from the web browser 80 to the WebSocket server 320 in step S115. Upon acquiring the first SDP information, the cloud server 300 transmits the first SDP information from the WebSocket server 320 to the projection application 91 in step S154. Upon acquiring the first SDP information, the projection application 91 transmits the first SDP information to the projection system 100 in step S107. Upon acquiring the first SDP information, the projection system 100 registers the first SDP information in the projection system storage 140 in step S133. In step S134, the projection system 100 transmits second SDP information to the projection application 91. Upon acquiring the second SDP information, the projection application 91 transmits the second SDP information to the cloud server 300 in step S109. Upon acquiring the second SDP information, the cloud server 300 transmits the second SDP information from the WebSocket server 320 to the controller 10 in step S156. Upon acquiring the second SDP information, the controller 10 registers the second SDP information in the memory 40 in step S117. The web browser 80 establishes WebRTC communication with the projection system 100.

When the WebRTC communication with the projection system 100 is established, the controller 10 transmits the shared data to the projection system 100 in step S119. The controller 10 transmits the shared data acquired by the capture application 81 to the projection system communicator 150 of the projection system 100 via the stream distribution path SP. By transmitting the shared data acquired by the capture application 81 to the projection system 100 via the stream distribution path SP, the controller 10 can transmit the shared data to the projection system 100 while preventing shared data quality deterioration. The projection application 91 can transmit the shared data to the projection system 100 using the function of the capture application 81.

When the controller 10 transmits the shared data, the projection system 100 receives the shared data in step S136. The stream communicator 151 of the projection system communicator 150 receives the shared data via the stream distribution path SP.

After receiving the shared data, the projection system 100 executes mirroring in step S137. When the video data is contained in the shared data, the projection system 100 acquires the video data in the shared data. The projection controller 131 of the projection system controller 130 transmits the video data to the projector 110. The projection controller 131 causes the projector 110 to project the video data. The projector 110 projects the projection image PG based on the video data onto the projection surface SC. When the audio data is contained in the shared data, the projection system 100 acquires the audio data in the shared data. The projection controller 131 of the projection system controller 130 transmits the audio data to the projection system built-in speaker 120. The projection system built-in speaker 120 outputs an audio based on the audio data. The projection system 100 projects, based on the shared data including the video data and the audio data, the display screen DS displayed on the display 15 of the controller 10, and outputs the audio based on the audio data. When the shared data is the audio data, the projection controller 131 of the projection system controller 130 transmits the audio data to the projection system built-in speaker 120. The projection system 100 outputs an audio based on the audio data. The projection system 100 executes mirroring based on the shared data including one of the video data and the audio data.

The control flow executed by the controller 10 includes communicatively connecting to the projection system 100, storing the projection application 91 that controls the projection system 100, executing the projection application 91, causing the projection application 91 to launch the capture application 81 on the web browser 80, causing the projection application 91 to transmit the control signal to the projection system 100 via the TCP/IP communication path TP, and causing the capture application 81 to acquire the shared data including at least one of the video data and the audio data output from the outputter 20.

By acquiring the shared data using the capture application 81 operating on the web browser 80, the controller 10 can prevent anomalies such as shared data quality deterioration. The projection application 91 can capture the shared data without having a function of acquiring the shared data.

In the control flow, it is preferable that the capture application 81 transmits the shared data to the projection system 100 via the stream distribution path SP different from the TCP/IP communication path TP.

By transmitting the shared data via the stream distribution path SP, the controller 10 can prevent shared data deterioration at the time when the shared data is transmitted to the projection system 100.

The shared data is capture data obtained by capturing at least one of the video data and the audio data output from the outputter 20.

The controller 10 can cause the projection system 100 to execute mirroring based on at least one of the video data and the audio data.

In the control flow illustrated in FIG. 6, the capture application 81 transmits the shared data to the projection system 100 via the stream distribution path SP, but the disclosure is not limited thereto. The projection application 91 may receive the shared data from the capture application 81 and transmit the shared data to the projection system 100.

The projection system 100 may not have a function of receiving the shared data using WebRTC technology. At this time, upon acquiring the shared data, the capture application 81 transmits the shared data to the projection application 91 via the WebSocket server 320. The projection application 91 receives the shared data. The projection application 91 transmits the shared data to the projection system communicator 150 of the projection system 100 via the TCP/IP communication path TP. The projection system communicator 150 receives the shared data and transmits the shared data to the projection system controller 130. The projection controller 131 of the projection system controller 130 transmits the video data in the shared data to the projector 110 and transmits the audio data in the shared data to the projection system built-in speaker 120. The projection system 100 executes mirroring based on the shared data using at least one of the projector 110 and the projection system built-in speaker 120. A communication method for transmitting the shared data from the capture application 81 to the projection application 91 via the WebSocket server 320 may be WebRTC communication or TCP/IP communication, and WebRTC communication is preferable. This is because communication speed of the WebRTC communication is faster than communication speed of the TCP/IP communication, and thus data transfer delay can be reduced.

It is preferable to cause the projection application 91 to acquire the shared data from the capture application 81.

The projection application 91 can transmit the shared data to the projection system 100 via the TCP/IP communication path TP by acquiring the shared data.

### Second Embodiment

A second embodiment shows a system configuration and a control flow of a second system 1b that is an example of the system 1. The second system 1b is an example of the system 1 when the projection system 100 includes the projection system server functional unit 133. The projection system server functional unit 133 has the same server function as the cloud server 300 shown in the first embodiment. The controller 10 transmits the shared data to the projection system 100 to execute mirroring for causing the projection system 100 to project the display screen DS displayed on the display 15. In the second system 1b, the projection system server functional unit 133 in the projection system 100 provides the web application to the controller 10. In the second system 1b, the server functional unit 35 of the controller 10 does not operate.

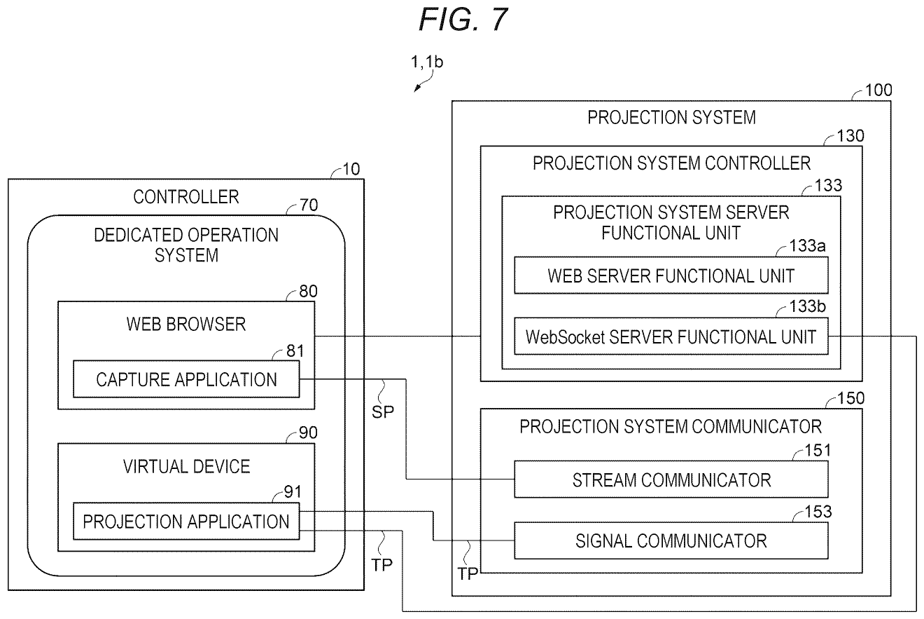

FIG. 7 illustrates a system configuration of the system 1. FIG. 7 schematically illustrates a system configuration of the second system 1b, which is an example of the system 1. FIG. 7 illustrates the controller 10 and the projection system 100. The configuration of the controller 10 illustrated in FIG. 7 is the same as the configuration of the controller 10 illustrated in FIG. 4.

FIG. 7 illustrates the projection system 100 including the projection system controller 130 and the projection system communicator 150. The configuration of the projection system communicator 150 illustrated in FIG. 7 is the same as the configuration of the projection system communicator 150 illustrated in FIG. 4. The projection system controller 130 includes the projection system server functional unit 133.

The projection system server functional unit 133 executes the same operation as the cloud server 300 illustrated in FIG. 4. The projection system server functional unit 133 includes a web server functional unit 133a and a WebSocket server functional unit 133b. The web server functional unit 133a performs the same operation as the web server 310 illustrated in FIG. 4. The WebSocket server functional unit 133b performs the same operation as the WebSocket server 320 illustrated in FIG. 4.

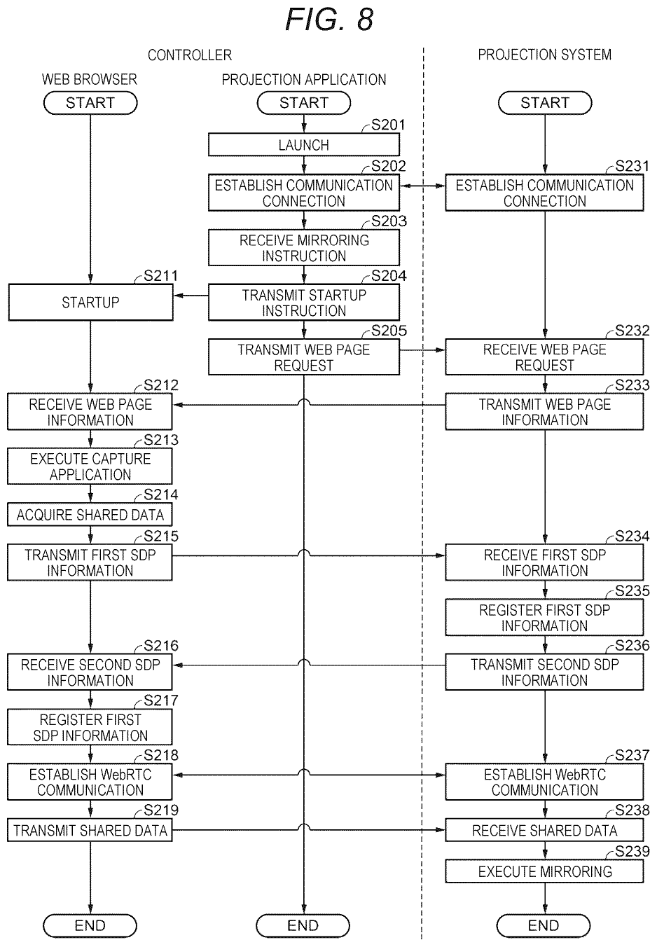

FIG. 8 illustrates a control flow executed by the system 1. FIG. 8 illustrates a control flow executed by the second system 1b, which is an example of the system 1. FIG. 8 illustrates a control flow executed by the controller 10 and the projection system 100. The controller 10 executes the control flow to execute mirroring for causing the projection system 100 to project the display screen DS displayed on the display 15.

In step S201, the controller 10 launches the projection application 91. Upon receiving a predetermined operation from the user, the controller 10 launches the projection application 91. The projection application 91 is launched in the virtual device 90. The projection application 91 is executed in a virtual environment.

After launching the projection application 91, the controller 10 establishes communication connection with the projection system 100 in step S202. The projection application 91 transmits a control signal such as a request for connection with the projection system 100 via the TCP/IP communication path TP to establish communication connection with the projection system 100.

After the projection application 91 is launched, the projection system 100 establishes communication connection with the controller 10 in step S231. The projection system 100 receives the control signal such as the connection request from the projection application 91 via the TCP/IP communication path TP. The projection system 100 transmits various data such as model information to establish the communication connection with the controller 10. When the communication connection with the controller 10 is established, the projection system 100 can receive various data from the controller 10.

After establishing the communication connection with the projection system 100, the controller 10 receives the mirroring instruction in step S203. When launched, the projection application 91 causes the display 15 to display the UI screen 170. When the user executes the predetermined operation on the mirroring reception icon 172 in the UI screen 170 displayed on the display 15, the mirroring reception icon 172 receives the mirroring instruction. Upon receiving the mirroring instruction, the projection application 91 generates various control signals such as the mirroring control signal corresponding to the mirroring instruction.

After receiving the mirroring instruction, the controller 10 transmits a startup instruction to the controller 30 in step S204. The projection application 91 transmits the startup instruction to the browser controller 31 of the controller 30. The browser controller 31 receives the startup instruction.

When the projection application 91 transmits the startup instruction to the browser controller 31, the controller 10 causes the web browser 80 to start up in step S211. When the web browser 80 is not launched, the browser controller 31 of the controller 30 causes the web browser 80 to start up based on the startup instruction. The web browser 80 is launched based on the startup instruction and displays a web page tab. The browser controller 31 displays a new web page tab when the web browser 80 starts up at the time of receiving the startup instruction.

After receiving the mirroring instruction, the controller 10 transmits the web page request to the projection system 100 in step S205. The projection application 91 transmits the web page request to the WebSocket server functional unit 133b in the projection system 100 via the TCP/IP communication path TP. The web page request includes a page address of the web page where the capture application 81 operates. The page address is stored in the memory 40 when the projection application 91 is installed in the controller 10.

When the projection application 91 transmits the web page request, the projection system 100 receives the web page request in step S232. The WebSocket server functional unit 133b in the projection system 100 receives the web page request transmitted from the projection application 91 via the TCP/IP communication path TP. The WebSocket server functional unit 133b transmits the web page request to the web server functional unit 133a. The web server functional unit 133a receives the web page request.

Upon receiving the web page request, the projection system 100 transmits web page information to the web browser 80 in step S233. The web server functional unit 133a acquires the web page information stored in the projection system storage 140 based on the page address in the web page request. The web page information is information on the web page where the capture application 81 operates. The web server functional unit 133a transmits the web page information to the web browser 80.

When the projection system 100 transmits the web page information, the controller 10 receives the web page information in step S212. Upon receiving the web page information, the web browser 80 displays the web page where the capture application 81 operates in the web page tab based on the web page information. The web browser 80 can execute the capture application 81.

After receiving the web page information, the controller 10 executes the capture application 81 in step S213. The web browser 80 executes the capture application 81 in the web page tab.

After executing the capture application 81, the controller 10 acquires the shared data in step S214. The web browser 80 causes the capture application 81 to acquire the shared data. The capture application 81 captures, as the capture data, the generated data output from the outputter 20 of the controller 10. The generated data includes at least one of the video data output from the display data outputter 21 and the audio data output from the audio outputter 23. The capture data is an example of the shared data including at least one of the video data and the audio data.

Upon acquiring the shared data, the controller 10 transmits first SDP information from the web browser 80 to the WebSocket server functional unit 133b in step S215. Upon acquiring the first SDP information, the projection system 100 registers the first SDP information in the projection system storage 140 in step S235. In step S236, the projection system 100 transmits the second SDP information to the capture application 81. Upon acquiring the second SDP information, the controller 10 registers the second SDP information in the memory 40 in step S217. The controller 10 establishes WebRTC communication with the projection system 100.

When the WebRTC communication with the projection system 100 is established, the controller 10 transmits the shared data to the projection system 100 in step S219. The controller 10 transmits the shared data acquired by the capture application 81 to the projection system communicator 150 of the projection system 100 via the stream distribution path SP. By transmitting the shared data acquired by the capture application 81 to the projection system 100 via the stream distribution path SP, the controller 10 can transmit the shared data to the projection system 100 while preventing shared data quality deterioration. The projection application 91 can transmit the shared data to the projection system 100 using the function of the capture application 81.

When the controller 10 transmits the shared data, the projection system 100 receives the shared data in step S238. The stream communicator 151 of the projection system communicator 150 receives the shared data via the stream distribution path SP.

After receiving the shared data, the projection system 100 executes mirroring in step S239. When the video data is contained in the shared data, the projection system 100 acquires the video data in the shared data. The projection controller 131 of the projection system controller 130 transmits the video data to the projector 110. The projection controller 131 causes the projector 110 to project the video data. The projector 110 projects the projection image PG based on the video data onto the projection surface SC. When the audio data is contained in the shared data, the projection system 100 acquires the audio data in the shared data. The projection controller 131 of the projection system controller 130 transmits the audio data to the projection system built-in speaker 120. The projection system built-in speaker 120 outputs an audio based on the audio data. The projection system 100 mirrors, based on the shared data including at least one of the video data and the audio data, the display screen DS displayed on the display 15 of the controller 10.

When the projection system 100 has a server function, the control flow preferably includes storing the capture application 81 by the projection system 100 and acquiring the capture application 81 from the projection system 100.

The controller 10 can acquire the capture application 81 from the projection system 100.

### Third Embodiment

A third embodiment shows a system configuration and a control flow of a third system 1c that is an example of the system 1. The third system 1c is an example of the system 1 when the controller 10 includes the server functional unit 35. The server functional unit 35 has the same server function as the cloud server 300 shown in the first embodiment. The controller 10 transmits the shared data to the projection system 100 to execute mirroring for causing the projection system 100 to project the display screen DS displayed on the display 15. In the third system 1c, the server functional unit 35 provides the function of the cloud server 300 illustrated in FIG. 4. In the third system 1c, the projection system 100 does not include the projection system server functional unit 133.

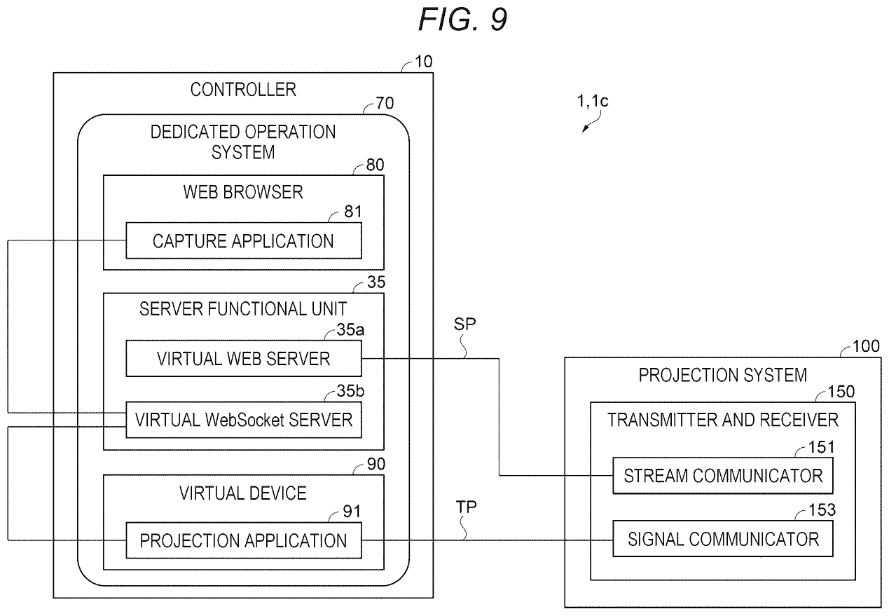

FIG. 9 illustrates a system configuration of the system 1. FIG. 9 schematically illustrates a system configuration of the third system 1c, which is an example of the system 1. FIG. 9 illustrates the controller 10 and the projection system 100. The configuration of the projection system 100 illustrated in FIG. 9 is the same as the configuration of the projection system 100 illustrated in FIG. 4.

In the controller 10 illustrated in FIG. 9, the server functional unit 35 functions as a virtual server. The server functional unit 35 operates as the virtual web server 35a and a virtual WebSocket server 35b. The virtual web server 35a executes the same operation as the web server 310 illustrated in FIG. 4. The virtual WebSocket server 35b executes the same operation as the WebSocket server 320 illustrated in FIG. 4.

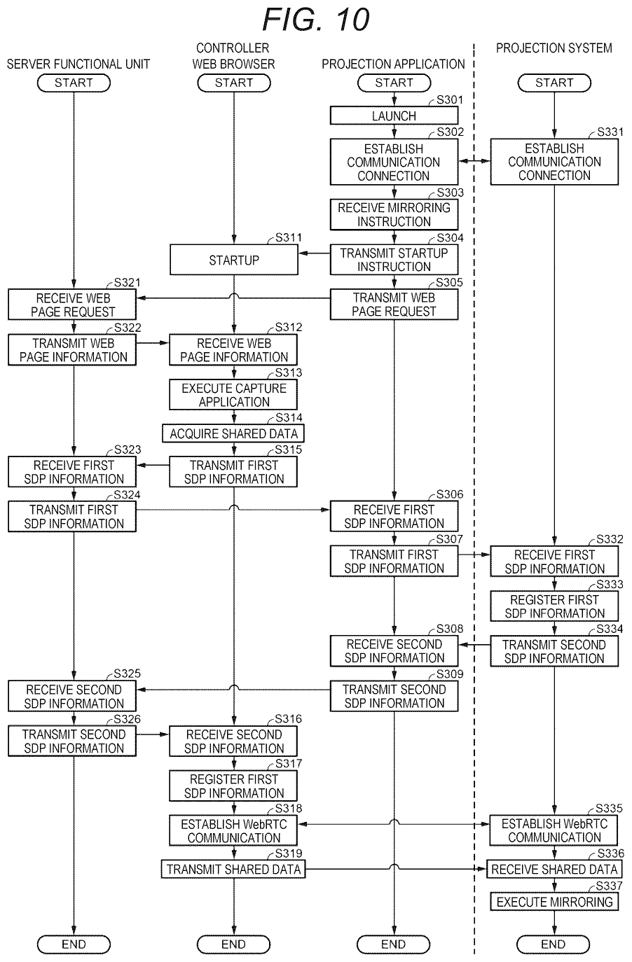

FIG. 10 illustrates a control flow executed by the system 1. FIG. 10 illustrates a control flow executed by the third system 1c, which is an example of the system 1. FIG. 10 illustrates a control flow executed by the controller 10 and the projection system 100. The controller 10 executes the control flow to execute mirroring for causing the projection system 100 to project the display screen DS displayed on the display 15.

In step S301, the controller 10 starts the projection application 91. Upon receiving a predetermined operation from the user, the controller 10 launches the projection application 91. The projection application 91 is launched in the virtual device 90. The projection application 91 is executed in a virtual environment.

After launching the projection application 91, the controller 10 establishes communication connection with the projection system 100 in step S302. The projection application 91 transmits a control signal such as a request for connection with the projection system 100 via the TCP/IP communication path TP to establish communication connection with the projection system 100.

After the projection application 91 is launched, the projection system 100 establishes communication connection with the controller 10 in step S331. The projection system 100 receives the control signal such as the connection request from the projection application 91 via the TCP/IP communication path TP. The projection system 100 transmits various data such as model information to establish the communication connection with the controller 10. When the communication connection with the controller 10 is established, the projection system 100 can receive various data from the controller 10.

After establishing the communication connection with the projection system 100, the controller 10 receives the mirroring instruction in step S303. When launched, the projection application 91 causes the display 15 to display the UI screen 170. When the user executes the predetermined operation on the mirroring reception icon 172 in the UI screen 170 displayed on the display 15, the mirroring reception icon 172 receives the mirroring instruction. Upon receiving the mirroring instruction, the projection application 91 generates various control signals such as the mirroring control signal corresponding to the mirroring instruction.

After receiving the mirroring instruction, the controller 10 transmits a startup instruction to the controller 30 in step S304. The projection application 91 transmits the startup instruction to the browser controller 31 of the controller 30. The browser controller 31 receives the startup instruction.

When the projection application 91 transmits the startup instruction to the browser controller 31, the controller 10 causes the web browser 80 to start up in step S311. When the web browser 80 is not launched, the browser controller 31 of the controller 30 causes the web browser 80 to start up based on the startup instruction. The web browser 80 is launched based on the startup instruction and displays a web page tab. The browser controller 31 displays a new web page tab when the web browser 80 starts up at the time of receiving the startup instruction.

After receiving the mirroring instruction, the controller 10 transmits the web page request to the server functional unit 35 in step S305. The projection application 91 transmits the web page request to the virtual web server 35a. The web page request includes a page address of the web page where the capture application 81 operates. The page address is stored in the memory 40 when the projection application 91 is installed in the controller 10.

When the projection application 91 transmits the web page request, the controller 10 receives the web page request in step S321. The virtual WebSocket server 35b operating in the controller 10 receives the web page request transmitted from the projection application 91. The virtual WebSocket server 35b transmits the web page request to the virtual web server 35a. The virtual web server 35a receives the web page request.

Upon receiving the web page request, the controller 10 transmits web page information to the web browser 80 in step S322. The virtual web server 35a acquires the web page information stored in the memory 40 based on the page address in the web page request. The web page information is information on the web page where the capture application 81 operates. The virtual web server 35a transmits the web page information to the web browser 80.

When the web page information is transmitted, the controller 10 receives the web page information in step S312. Upon receiving the web page information, the web browser 80 displays the web page where the capture application 81 operates in the web page tab based on the web page information. The web browser 80 can execute the capture application 81.

After receiving the web page information, the controller 10 executes the capture application 81 in step S313. The web browser 80 executes the capture application 81 in the web page tab.

After executing the capture application 81, the controller 10 acquires the shared data in step S314. The web browser 80 causes the capture application 81 to acquire the shared data. The capture application 81 captures, as the capture data, the generated data output from the outputter 20 of the controller 10. The generated data includes at least one of the video data output from the display data outputter 21 and the audio data output from the audio outputter 23. The capture data is an example of the shared data including at least one of the video data and the audio data.

Upon acquiring the shared data, the controller 10 transmits first SDP information from the web browser 80 to the virtual WebSocket server 35b in step S315. Upon acquiring the first SDP information, the server functional unit 35 transmits the first SDP information from the virtual WebSocket server 35b to the projection application 91 in step S324. Upon acquiring the first SDP information, the projection application 91 transmits the first SDP information to the projection system 100 in step S307. Upon acquiring the first SDP information, the projection system 100 registers the first SDP information in the projection system storage 140 in step S333. In step S334, the projection system 100 transmits second SDP information to the projection application 91. Upon acquiring the second SDP information, the projection application 91 transmits the second SDP information to the virtual WebSocket server 35b in step S309. Upon acquiring the second SDP information, the server functional unit 35 transmits the second SDP information from the virtual WebSocket server 35b to the web browser 80 in step S326. Upon acquiring the second SDP information, the web browser 80 registers the second SDP information in the memory 40 in step S317. The web browser 80 establishes WebRTC communication with the projection system 100.

When the WebRTC communication with the projection system 100 is established, the controller 10 transmits the shared data to the projection system 100 in step S319. The controller 10 transmits the shared data acquired by the capture application 81 to the projection system communicator 150 of the projection system 100 via the stream distribution path SP. The controller 10 transmits the shared data to the projection system communicator 150 in real time via the stream distribution path SP. By transmitting the shared data acquired by the capture application 81 to the projection system 100 via the stream distribution path SP, the controller 10 can transmit the shared data to the projection system 100 while preventing shared data quality deterioration. The projection application 91 can transmit the shared data to the projection system 100 using the function of the capture application 81.

When the controller 10 transmits the shared data, the projection system 100 receives the shared data in step S336. The stream communicator 151 of the projection system communicator 150 receives the shared data via the stream distribution path SP.

After receiving the shared data, the projection system 100 executes mirroring in step S337. When the video data is contained in the shared data, the projection system 100 acquires the video data in the shared data. The projection controller 131 of the projection system controller 130 transmits the video data to the projector 110. The projection controller 131 causes the projector 110 to project the video data. The projector 110 projects the projection image PG based on the video data onto the projection surface SC. When the audio data is contained in the shared data, the projection system 100 acquires the audio data in the shared data. The projection controller 131 of the projection system controller 130 transmits the audio data to the projection system built-in speaker 120. The projection system built-in speaker 120 outputs an audio based on the audio data. The projection system 100 executes mirroring based on the shared data including at least one of the video data and the audio data.

When the controller 10 has a server function, the control flow preferably includes storing the capture application 81 in the memory 40 and acquiring the capture application 81 from the memory 40.

The controller 10 can acquire the capture application 81 without connecting to the cloud server 300 or the like.

A summary of the present disclosure is appended below.

### Appendix 1

An information processing method including: establishing a communication connection with a projection apparatus; storing an application program for controlling the projection apparatus; executing the application program; causing the application program to launch a web application program on a web browser; causing the application program to transmit a control signal to the projection apparatus via a signal communication path; and causing the web application program to acquire output data including at least one of video data and audio data output from an outputter.

By acquiring the output data using the web application program operating on the web browser, an information processing apparatus can prevent anomalies such as shared data quality deterioration. The application program can be caused to capture the output data without having a function of acquiring the output data.

### Appendix 2

The information processing method according to Appendix 1, further including: causing the web application program to transmit the output data to the projection apparatus via a browser communication path different from the signal communication path.

By causing the output data to be transmitted via the browser communication path, the information processing apparatus can prevent output data deterioration at the time when the output data is transmitted to the projection apparatus.

### Appendix 3

The information processing method according to Appendix 1, further including: causing the application program to acquire the output data from the web application program; and causing the application program to transfer the output data to the projection apparatus via the signal communication path.

The information processing apparatus can transmit the output data to the projection apparatus that does not support WebRTC technology.

### Appendix 4

The information processing method according to any one of appendices 1 to 3, further including: when the projection apparatus has a server function, storing the web application program by the projection apparatus, and acquiring the web application program from the projection apparatus.

The information processing apparatus can acquire the web application program from the projection apparatus.

### Appendix 5

The information processing method according to any one of Appendices 1 to 3, further including: when a server function is provided, storing the web application program in a storage, and acquiring the web application program from the storage.

The information processing apparatus can acquire the web application program without connecting to an external server or the like.

### Appendix 6

The information processing method according to any one of Appendices 1 to 5, in which the output data is capture data obtained by capturing at least one of the video data and the audio data output from the outputter.

The information processing apparatus can cause the projection apparatus to execute mirroring based on the output data.

What is claimed is:

1. An information processing method comprising:
establishing a communication connection with a projection apparatus;
storing an application program for controlling the projection apparatus;
executing the application program;
causing the application program to launch a web application program on a web browser;
causing the application program to transmit a control signal to the projection apparatus via a signal communication path; and
causing the web application program to acquire output data including at least one of video data and audio data which are output from an outputter.

2. The information processing method according to claim 1, further comprising:
causing the web application program to transmit the output data to the projection apparatus via a browser communication path different from the signal communication path.

3. The information processing method according to claim 1, further comprising:
causing the application program to acquire the output data from the web application program; and
causing the application program to transfer the output data to the projection apparatus via the signal communication path.

4. The information processing method according to claim 1, further comprising:
when the projection apparatus has a server function,
storing the web application program by the projection apparatus, and
acquiring the web application program from the projection apparatus.

5. The information processing method according to claim 1, further comprising:
when a server function is provided,
storing the web application program in a storage, and
acquiring the web application program from the storage.

6. The information processing method according to claim 1, wherein
the output data is capture data obtained by capturing at least one of the video data and the audio data which are output from the outputter.
